(19) United States
(12) Patent Application Publication
(10) Pub. No.: US 2025/0206070 A1
(43) Pub. Date: Jun. 26, 2025

(54) VEHICLE TIRE WITH VEHICLE TIRE IDENTIFIER

(71) Applicant: Continental Reifen Deutschland GmbH, Hannover (DE)

(72) Inventors: Lubos Kuniak, Ladce (SK); Peter Bogenschütz, Wedemark (DE)

(73) Assignee: Continental Reifen Deutschland GmbH, Hannover, OT (DE)

(21) Appl. No.: 18/846,429

(22) PCT Filed: Jan. 30, 2023
(86) PCT No.: PCT/DE2023/200023

§ 371 Date: Sep. 12, 2024

(30) Foreign Application Priority Data
Mar. 15, 2022 (DE) 10 2022 202 534.2

(51) Int. Cl. B60C 13/00; B29D 30/72

(52) U.S. Cl. CPC B60C 13/001; B29D 30/72; B29D 2030/726

(57) ABSTRACT

The invention relates to a vehicle tire comprising a tread provided for contacting the road surface, and two sidewalls which adjoin the tread. At least one sidewall has an identifier region. The identifier region comprises a multiplicity of identifier grooves which extend in the sidewall of the vehicle tire (10). The identifier grooves have in each case one inner corrugation having a multiplicity of elongate elevations and/or depressions which in the interior of the identifier grooves run transversely to the longitudinal direction of the identifier grooves. The elongate elevations and depressions, conjointly with the longitudinal direction of the identifier grooves, include in each case an angle in the range of 20° to 90°.

### BRIEF SUMMARY

The invention relates to a vehicle tire with a vehicle tire identifier, and to a method for producing corresponding vehicle tires. Moreover disclosed is the use of a multiplicity of specific identifier grooves for improved identification of the sidewall of a vehicle tire.

At least one sidewall of the vehicle tires is in most instances clearly visible during storage of vehicle tires as well as when the latter are in use on the vehicle. Moreover, the surface properties and the surface structure of the tire sidewalls in many cases have a comparatively small influence on the driving characteristics of the vehicle tires, especially in comparison to the tread. For this reason, the sidewall of vehicle tires is typically used to identify vehicle tires.

This identifier may be, for example, the labeling of items of information pertaining to the type of tire or the tire manufacturer, or else items of information pertaining to the intended use or to particular advantages of the tire. Moreover, warning and information signs, often in the form of pictograms, are used in many cases, for example by means of which safety-relevant items of information can be read quickly.

Apart from the identification of tire sidewalls, which is mainly used for information purposes, the contrast-based design of the mostly black tire sidewall also partially serves to conceal material irregularities that may remain in the sidewall during tire production and which could negatively affect user acceptance.

Moreover, from various points of view, for example under safety aspects, there is a need to specifically adjust the light scattering behavior of the surface of the tire sidewall by the design of the tire sidewall, for example, to surround reflective elements with particularly matt-appearing, i.e. diffusely scattering, regions.

Especially when the tire sidewall is identified by pictograms, for example, the representable information density is typically restricted by the contrast differences achievable on the mostly black tire sidewall and the limited adjustability of contrast effects. Also when masking optical material defects by means of the sidewall designs and adjusting the light scattering behavior, it is desirable to be able to implement as fine contrast differences as possible and as smooth differences in the brightness effect as possible.

In the state of the art, the generation of contrasts on the tire sidewall, which can be used, for example, for identification, is currently carried out, in particular by disposing groove structures, i.e. elongate elevations or depressions, in the sidewall. Examples of corresponding identifiers are disclosed in U.S. Pat. No. 5,645,661, 10,870,316 B2, U.S. Pat. No. 10,322,610 B2, U.S. Pat. No. 6,253,815 B1 or U.S. Pat. No. 10,029,518 B2.

Different contrasts between lighter and darker regions of the tire sidewall can be achieved mainly by changing the groove width and/or groove depth as well as by adjusting the number of grooves per surface, i.e. the groove density or groove orientation. At the same time, in many cases there is a functional maximum of many of these parameters, in particular the possible groove depth and groove density, which is defined in particular by the required stability of the tire sidewall and the methods used for production. Moreover, very pronounced, deep groove structures can result in a very rough surface structure which can cause unfavorable aerodynamic characteristics and unwanted air turbulences which can adversely affect, for example, the fuel consumption or the range of electric vehicles. Moreover, the material webs between two grooves can often not be designed as narrow as desired, as these webs then lack the necessary stability and load bearing capability, so that the identifier on the tire sidewall can be very easily damaged. Moreover, the minimum width of the complementary webs in the molded parts is in many cases limited by the precision of the material-removing processes used for the machining of the material of the molded parts in the production method by a vulcanization mold. Therefore, the groove density can usually not be increased arbitrarily, which further limits the achievable contrast differences. Moreover, very deep grooves in particular also represent a source of unwanted and hard-to-remove dirt deposits during driving, which can adversely affect user acceptance due to poor cleanability of the vehicle tires. In the case of particularly deep grooves, there is also the risk that the underlying components in the vehicle tire, for example the strength members of the carcass, will be undesirably exposed.

It was the primary object of the present invention to eliminate or at least reduce the above-described disadvantages of the prior art.

In particular, it was the object of the present invention to specify a vehicle tire with an improved vehicle tire identifier which by suitable measures allows a greater diversity of contrasts and the setting of finer contrast gradients in comparison to the prior art. It was desirable that the measures used should influence the sidewall stability as little as possible, even when pronounced contrasts are set. Moreover, strong contrasts and fine contrast gradients should ideally be achievable without the use of very pronounced depressions or the need for very thin material webs, so that good cleanability and advantageous aerodynamic characteristics can in particular be achieved.

The inventors have now recognized that the above-described objects can be surprisingly achieved when a multiplicity of identifier grooves, which can be formed in particularly preferred design embodiments as identifier grooves that are concentric with the vehicle tire and in the interior are additionally provided with an inner corrugation transverse to the longitudinal direction, as is defined in the claims, are used, wherein the variation of the disposal and design embodiment of the identifier grooves in combination with the variation of the disposal and design embodiment of the inner corrugation allows the setting of an advantageously high contrast diversity and the implementation of fine contrast gradients, and this at a comparatively low mean groove depth.

The above-mentioned objects are thus achieved by the subject matter of the invention as defined in the claims. Preferred design embodiments according to the invention are derived from the dependent claims and from the explanations hereunder.

In particularly preferred embodiments, embodiments that are referred to as preferred hereunder are combined with features of other embodiments that are referred to as preferred. Combinations of two or more of the embodiments that are referred to as particularly preferred hereunder are thus most particularly preferred. Likewise preferred are embodiments in which a feature of one embodiment that is referred to as preferred to a certain extent is combined with one or more further features of other embodiments that are referred to as preferred to a certain extent. Characteristics of preferred methods and uses are derived from the characteristics of preferred vehicle tires.

The invention relates in particular to a vehicle tire comprising a tread which is provided for contacting the road surface, and two sidewalls which adjoin the tread, wherein at least one sidewall comprises at least one identifier region;

wherein the identifier region comprises a multiplicity of identifier grooves which extend in the sidewall of the vehicle tire;

wherein the identifier grooves have in each case one inner corrugation having a multiplicity of elongate elevations and/or depressions which in the interior of the identifier grooves run transversely to the longitudinal direction of the identifier grooves in such a way that the elongate elevations and depressions, conjointly with the longitudinal direction of the identifier grooves, include in each case an angle in the range of 20° to 90°.

In accordance with the expectations of a person skilled in the art, the vehicle tire according to the invention comprises a tread as well as two sidewalls, whereby these elements extend in each case across the circumference of the vehicle tire.

The vehicle tire according to the invention comprises an identifier region, as a result of which that region of the sidewall surface is described in which the identifier is present due to the specific disposal of identifier grooves and inner corrugation. The identifier region is determined by the dimensions of the identifier and corresponds, for example, to the size of the pictogram in the case of a circular pictogram.

For identification, the vehicle tire according to the invention initially comprises, similar to the prior art, a multiplicity of identifier grooves which extend in the identifier region on the tire sidewall and which are elongate recesses or depressions in the material, which can be embossed into the tire sidewall by means of a complementary, contoured vulcanization mold, particularly in the course of vulcanizing a vehicle tire blank.

In contrast to the prior art, however, the identifier grooves are not substantially smooth, but comprise in their interior at least in portions a specific inner corrugation, i.e. a region in which the identifier groove has a macroscopically structured surface. In accordance with the understanding of a corrugation by a person skilled in the art, the inner corrugation is formed by a plurality of elevations or depressions in the inner face of the identifier grooves, whereby the inner corrugation can also comprise elevations as well as depressions. The person skilled in the art understands that the boundaries between i) elevations in a lower plane, and ii) depressions in a higher plane, or iii) alternating elevations and depressions, may become blurred depending on the design embodiment of the inner corrugation, whereby the person skilled in the art can readily detect an inner corrugation in practice, without it being necessary to determine which of the cases this may most likely be.

The elevations and/or depressions extend, as is customary with a corrugation, as elongate elevations or depressions in the identifier groove. The inventors have recognized that for achieving the advantageous contrast diversity and for maintaining very gentle contrast gradients, it is necessary to dispose the elevations and/or depressions of the inner corrugation transversely to the longitudinal direction of the identifier groove, which can be expediently expressed by the angle between the respective elongate elevations and/or depressions and the longitudinal direction of the identifier grooves.

In accordance with the understanding of a person skilled in the art, the longitudinal direction of an identifier groove is the direction along the longest longitudinal extent of the identifier groove and will correspond to the centerline of the identifier groove for the vast majority of the identifier grooves. For example, the longitudinal direction of a straight identifier groove, which runs orthogonally to the radial direction of the vehicle tire only at one location and extends, for example, as a horizontally running identifier groove in the tire sidewall, likewise runs orthogonally to this radial direction at this location. Alternatively, the longitudinal direction of a curved identifier groove, which at each point runs orthogonally to the radial direction of the vehicle tire and is correspondingly concentric with the vehicle tire, runs along or parallel to the circumferential direction of the vehicle tire and thus is also concentric with the vehicle tire.

The determination of the angle between the elongate elevations or depressions and the longitudinal direction of the identifier grooves in practice does not constitute a difficulty for the skilled person. As is customary with such angle specifications, the smaller of the two included angles is evaluated, whereby an elevation running exactly transversely to the longitudinal direction with the longitudinal direction would include, for example, an angle of 90°. If the elongate elevations and depressions should have a more complex shape or a more complex gradient, which is however less favorable in view of the complexity in terms of manufacturing, the mean value of the intersection angle with the longitudinal direction of the identifier groove along the longitudinal direction of the elongate elevations and depressions shall be used in accordance with the understanding of a person skilled in the art.

The present form of identifier is particularly suitable for pneumatic vehicle tires, particularly in the passenger motor vehicle sector, and can advantageously be readily combined with customary profiles in the tread. Preferred therefore is a vehicle tire according to the invention wherein the vehicle tire is a passenger motor vehicle or a motor truck tire, preferably a passenger motor vehicle tire. Also preferred is a vehicle tire according to the invention wherein the vehicle tire is a pneumatic vehicle tire. Also preferred is a vehicle tire according to the invention wherein the tread has a profile.

Since only one side of the vehicle tires is usually visible in use, it is expedient to identify said vehicle tires only on one side with a view to the complexity in terms of manufacturing. Therefore, a vehicle tire according to the invention is preferred, wherein exactly one sidewall comprises at least one identifier region.

In view of the advantages of the vehicle tires according to the invention and the great design possibilities in the adjustment of contrasts, it is preferred when the specific form of identifier is also widely used, wherein this specific form of identifier preferably can replace all conventional identifiers, for example in the form of a plurality of separate identifier regions or one region extending across large parts of the tire sidewall. Therefore, a vehicle tire according to the invention is preferred, wherein the vehicle tire comprises two or more, preferably three or more, identifier regions, and/or wherein at least one identifier region extends across 50% or more, preferably 70% or more, particularly preferably 90% or more, of the circumference of the vehicle tire.

The identifier regions of the vehicle tires according to the invention are advantageously particularly suitable for the reproduction of graphic designs, wherein the large achievable contrast diversity enables a high information density. A vehicle tire according to the invention is preferably used, wherein the identifier region serves to identify the vehicle tire by an identifier, preferably a warning and/or pictogram, wherein the identifier is formed by disposing the identifier grooves and the inner corrugation.

Particularly when applying complex designs and graphic identifiers, it has proven advantageous to provide a plurality of identifier grooves in order to be able to also implement, for example, comparatively complex pictograms. Accordingly, a vehicle tire according to the invention is preferred, wherein the identifier region comprises five or more, preferably ten or more, particularly preferably fifteen or more, most particularly preferably twenty or more, identifier grooves.

A vehicle tire according to the invention is preferred, wherein the identifier grooves at least partially, preferably predominantly, particularly preferably for substantially all identifier grooves, at least in portions, preferably across the entire length, have a U-shaped or V-shaped or a substantially rectangular groove cross section, preferably a U-shaped or substantially rectangular groove cross section. Particularly in the case of substantially rectangular groove cross sections, the inner corrugation can be disposed particularly efficiently on the base of the groove, as a result of which a particularly pronounced influence on the contrast can be achieved.

Advantageously, the specific arrangement of identifier grooves and inner corrugation can also be combined with conventional methods for generating contrast, so that the spectrum of the achievable brightness and shading levels can be even further increased. Therefore, a vehicle tire according to the invention is preferred, wherein the identifier grooves at least partially, preferably predominantly, particularly preferably for substantially all identifier grooves, have in each case a varying groove width and/or varying groove cross section along the longitudinal direction. Preferred is additionally or alternatively a vehicle tire according to the invention, wherein the identifier grooves at least partially, preferably predominantly, particularly preferably between two adjacent identifier grooves, have a varying mean groove width and/or a varying maximum groove width and/or a varying mean groove depth and/or a varying maximum groove depth and/or a varying groove cross section.

According to the inventors' assessment, particularly visually appealing identifiers are obtained in particular when the identifier grooves run out smoothly at the ends. From a technical point of view, this has the added advantage of forming fewer sharp edges that can catch foreign matter, thus reducing the risk of damage and improving cleanability. Accordingly, a vehicle tire according to the invention is preferred, wherein the identifier grooves at least partially, preferably predominantly, particularly preferably for substantially all identifier grooves, taper in each case in the end regions, preferably in terms of the groove width and/or the groove depth, particularly preferably in terms of the groove depth.

The inventors have been successful in identifying the customary size ranges for the identifier grooves for typical vehicle tires, which can be used to obtain identifiers with excellent contrast gradients. In this respect, a vehicle tire according to the invention is preferred, wherein the identifier grooves at least partially, preferably predominantly, particularly preferably for substantially all identifier grooves, have a groove length in the range of 25 to 1000 mm, preferably in the range of 100 to 750 mm, particularly preferably in the range of 200 to 400 mm, and/or wherein the identifier grooves at least partially, preferably predominantly, particularly preferably for substantially all identifier grooves, have a groove length in the range of 0.01*u to 0.35*u, preferably in the range of 0.05*u to 0.25*u, particularly preferably in the range of 0.1*u to 0.2*u, where u is the internal circumference of the vehicle tire.

Preferred additionally or alternatively is a vehicle tire according to the invention, wherein the identifier grooves at least partially, preferably predominantly, particularly preferably for substantially all identifier grooves, have an average groove width in the range of 1 to 9 mm, preferably in the range of 1 to 6 mm, particularly preferably in the range of 1 to 4 mm, and/or wherein the identifier grooves at least partially, preferably predominantly, particularly preferably for substantially all identifier grooves, have a maximum groove width in the range of 0.5 to 10 mm, preferably in the range of 1 to 6 mm, particularly preferably in the range of 1.5 to 5 mm. Preferred additionally or alternatively is a vehicle tire according to the invention, wherein the identifier grooves at least partially, preferably predominantly, particularly preferably for substantially all identifier grooves, have a mean groove depth in the range of 0.1 to 1 mm, preferably in the range of 0.15 to 0.6 mm, particularly preferably in the range of 0.2 to 0.4 mm, and/or wherein the identifier grooves at least partially, preferably predominantly, particularly preferably for substantially all identifier grooves, have a maximum groove depth in the range of 0.2 to 1 mm, preferably in the range of 0.2 to 0.5 mm, particularly preferably in the range of 0.25 to 0.35 mm.

In the estimation of the inventors, particularly good results can be achieved in terms of the identifier particularly when the identifier grooves are embodied so as to be bent in such a manner that they at least partially retrace the curvature of the vehicle tire sidewall, in particular wherein such identifier grooves which are concentric with the vehicle tire, i.e. which run on an orbit having the same center as the vehicle tire, are particularly advantageous. This corresponds to an identifier groove of which the longitudinal direction, or centerline, over the entire length of the groove, conjointly with the radial direction of the vehicle tire, includes an angle of 90°. Therefore, a vehicle tire according to the invention is preferred, wherein the identifier grooves at least partially, preferably predominantly, particularly preferably for substantially all identifier grooves, at least in portions, preferably over the entire groove length, conjointly with the radial direction of the vehicle tire, include an angle in the range of 70° to 90°, preferably in the range of 80° to 90°, particularly preferably in the range of 85° to 90°, most preferably substantially of 90°.

Preferred is vehicle tire according to the invention, wherein the identifier grooves at least partially, preferably predominantly, particularly preferably for substantially all identifier grooves, are disposed so as to be mutually parallel. Preferred additionally or alternatively is a vehicle tire according to the invention, wherein the mean distance between two adjacent identifier grooves is in the range of 0.5 to 10 mm, preferably in the range of 1 to 6 mm, particularly preferably in the range of 1.5 to 5 mm. Also preferred additionally or alternatively is a vehicle tire according to the invention, wherein the centerlines of all identifier grooves at least in portions, preferably across the entire length, are disposed so as to be mutually spaced apart equidistantly. The corresponding design embodiments not only typically result in an optically particularly appealing identifier, but are also advantageous from a manufacturing point of view, as they can be implemented particularly reliably and efficiently with automated material-removing processes in a vulcanization mold, for example.

Even if it is conceivable, for example, in the case of V-shaped identifier grooves, to provide the inner corrugation at least in part also in the wall regions of the identifier grooves, a disposal on the base of the identifier grooves is advantageous with a view to the achievable optical effect. Also preferred accordingly is a vehicle tire according to the invention, wherein the inner corrugation is disposed on the base of the identifier grooves.

In a manner analogous to the above explanations pertaining to the number of identifier grooves, it is favorable with regard to the improvement of the adjustability of contrasts to provide in each case a larger number of elevations or depressions, wherein particularly pronounced contrasts can be obtained when elevations and depressions are disposed alternately, wherein it is preferred for all design embodiments that the inner corrugation extends in each case across the entire width of the identifier grooves. Against this background, a vehicle tire according to the invention is preferred, wherein the inner corrugation in each identifier groove has in each case 15 or more, preferably 30 or more, particularly preferably 45 or more, elevations and/or depressions. Preferred accordingly is also a vehicle tire according to the invention, wherein the inner corrugation comprises a plurality of, preferably alternating, elongate elevations and depressions. Also preferred additionally or alternatively is a vehicle tire according to the invention, wherein the elongate elevations or depressions extend predominantly, preferably to more than 80%, particularly preferably substantially completely, in each case from one periphery of the identifier groove to the other periphery of the identifier groove.

The inventors have also succeeded in specifying particularly suitable dimensions for the inner corrugation. Specifically preferred is a vehicle tire according to the invention, wherein the elongate elevations or depressions along the longitudinal direction of the identifier groove to the next elevation or depression have a spacing in the range of 0.2 to 2 mm, preferably in the range of 0.3 to 1.5 mm, particularly preferably in the range of 0.5 to 1 mm, in terms of the centerlines of the elevations or depressions.

Preferred additionally or alternatively is a vehicle tire according to the invention, wherein the elongate elevations or depressions have a mean width along the longitudinal direction of the identifier groove in the range of 0.01*b to 0.2*b, preferably in the range of 0.02*b to 0.1*b, wherein b is the mean width of the identifier groove. Moreover, a vehicle tire according to the invention is preferred, wherein the elongate elevations or depressions in each identifier groove, preferably in all identifier grooves, have the same cross-sectional shape and width.

The specific design embodiment of the vehicle tires according to the invention allows, in particular also due to the number and positioning of the elements of the inner corrugation, the brightness effect achieved in a range to be controlled. Therefore, a vehicle tire according to the invention is preferred, wherein the spacing between two adjacent elongate elevations or depressions varies along the longitudinal direction of the identifier groove, and/or wherein the density of elongate elevations and/or depressions per unit length varies along the longitudinal direction of the identifier groove. Additionally or alternatively, a vehicle tire according to the invention is preferred, wherein the total number of elongate elevations or depressions differs between different identifier grooves.

The inventors were also able to identify preferred values with regard to the angles of the elongate elevations or depressions relative to the longitudinal direction. Specifically preferred is a vehicle tire according to the invention, wherein the elongate elevations and/or depressions, conjointly with the longitudinal direction of the identifier grooves, include in each case an angle of 30° or more, preferably of 40° or more, particularly preferably of 50° or more, and/or wherein the elongate elevations and/or depressions, conjointly with the longitudinal direction of the identifier grooves, include in each case an angle in the range of 25° to 85°, preferably in the range of 35° to 75°, particularly preferably in the range of 45° to 65°. Particularly preferred is a vehicle tire according to the invention, wherein all of the elongate elevations or depressions, conjointly with the longitudinal direction of the identifier grooves, include substantially the same angle. Preferred additionally or alternatively is a vehicle tire according to the invention, wherein the elongate elevations or depressions of an identifier groove, preferably the elongate elevations or depressions of all identifier grooves, run so as to be substantially mutually parallel.

Moreover, it can be expedient to provide a specific alignment of the elevations or depressions relative to the radial direction of the vehicle tire. Specifically preferred is a vehicle tire according to the invention, wherein the elongate elevations and/or depressions, conjointly with the radial direction of the vehicle tire, include an angle in the range of 0° to 70°, preferably in the range of 0° to 60°, particularly preferably in the range of 0° to 50°, most preferably in the range of 0° to 40°, and/or wherein the elongate elevations or depressions, conjointly with the radial direction of the vehicle tire, include an angle of 10° or more, preferably 20° or more, more preferably 30° or more.

Particularly in the production of the vehicle tire by way of a vulcanization mold having an identifier embossing region for molding the identifier region, it is advantageous when the elongate elevations or depressions in the identifier grooves are embodied so as to be largely co-aligned with one another. This is due to the fact that during the production of the molded parts, the identifier elevations are usually formed first, on which the surface corrugation is then generated with material-removing processes, which is later to be transferred in the vehicle tires. From a manufacturing point of view, it is useful to move the tools used for machining substantially in straight lines transversely to the identifier elevations, so that co-aligned elevations and/or depressions are created on adjacent identifier elevations, which result in complementary, co-aligned elevations and/or depressions in the identifier grooves during vulcanization. Preferred is accordingly a vehicle tire according to the invention, wherein the elongate elevations and/or depressions of an identifier groove, preferably of all identifier grooves, are at least partially, preferably predominantly, particularly preferably substantially completely, co-aligned with elongate elevations and/or depressions of an adjacent identifier groove. It is particularly preferred in this respect if, apart from the outermost elevations and/or depressions of the outermost identifier grooves in the identifier region, all elevations and/or depressions are co-aligned with elongate elevations and/or depressions of an adjacent identifier groove. It is also particularly preferred in this respect if the elevations and/or depressions in the middle third of the identifier grooves are co-aligned with elongate elevations and/or depressions of a plurality of other identifier grooves.

Preferred is a vehicle tire according to the invention, wherein the surface proportion of identifier grooves and/or the surface proportion of elongate elevations or depressions in the identifier region varies between two sub-surfaces of the identifier region, and/or wherein the identifier region comprises a plurality of sub-surfaces which differ from one other in terms of the surface proportions of identifier grooves and/or elongate elevations and/or depressions.

The inventors have succeeded in identifying a method for the particularly efficient production of the vehicle tires according to the invention. The invention specifically also relates to a method for producing a vehicle tire according to the invention, comprising the following method steps:
a) producing a non-vulcanized vehicle tire blank, comprising a vulcanizable rubber compound in at least one component of the sidewall of the non-vulcanized vehicle tire blank, and
b) vulcanizing the non-vulcanized vehicle tire blank in a vulcanization mold to obtain a vehicle tire;
wherein the vulcanization mold in the region of at least one sidewall of the vehicle tire comprises an identifier embossing region, wherein the identifier embossing region comprises a plurality of elongate identifier elevations, wherein the elongate identifier elevations each have a surface corrugation having a multiplicity of elongate elevations and/or depressions which on the surface of the elongate identifier elevations run transversely to the longitudinal direction of the identifier elevations in such a way that the elongate elevations and depressions, conjointly with the longitudinal direction of the identifier elevations, include in each case an angle in the range of 20° to 90°. The elevations and/or depressions of the surface corrugation can also be referred to as embossing elevations or embossing depressions, if necessary, so as to distinguish them from the elevations and/or depressions of the inner corrugation of the vehicle tire.

The invention also discloses a method for producing a vehicle tire according to the invention, comprising the following method steps:
a) producing a non-vulcanized vehicle tire blank; and
b) vulcanizing the non-vulcanized vehicle tire blank to obtain a vehicle tire;
wherein the identifier region in the sidewall of the vehicle tire is generated by a material-removing process, in particular while using a laser.

In the method according to the invention, the vulcanization mold thus comprises in the region of the later identifier region an identifier embossing region which by way of the identifier elevations and the surface corrugation disposed thereon, comprises elements that are complementary to the identifier grooves and the inner corrugation, so that the vulcanization is performed in such a way that the identifier region in the vehicle tire is molded as a negative of the identifier embossing region.

The identifier embossing region required for the method according to the invention can advantageously be generated with customary processes in the vulcanization mold. A method according to the invention is preferred, wherein the vulcanization mold is produced by a material-removing process.

In comparison to the prior art, the method according to the invention is not limited in respect of the vulcanizable rubber compound used in the non-vulcanized vehicle tire blank, since already today the customary rubber compounds used in the production of vehicle tires on the surface of the vehicle tires are conceived to have structure applied thereon or embossed therein in the course of vulcanization. Exemplary is a method according to the invention wherein the vulcanizable rubber compound comprises at least one diene rubber, wherein the diene rubber is preferably selected from the group consisting of natural polyisoprene, synthetic polyisoprene, epoxidized polyisoprene, butadiene rubber, solution polymerized styrene-butadiene rubber, emulsion-polymerized styrene-butadiene rubber, polynorbornene, ethylene-propylene-diene rubber, styrene-isoprene-butadiene terpolymer, and isoprene-butadiene copolymer, whereby the diene rubber is particularly preferably selected from the group consisting of natural polyisoprene (NR), synthetic polyisoprene (IR), butadiene rubber (BR), solution polymerized styrene-butadiene rubber (SSBR) and emulsion polymerized styrene-butadiene rubber (ESBR).

Disclosed in the context of the invention is moreover the use of a multiplicity of identifier grooves for the improved identification of the sidewall of a vehicle tire with more precise adjustability of contrast differences and/or the reflectivity, wherein the identifier grooves each have an inner corrugation with a multiplicity of elongate elevations and/or depressions which in the interior of the identifier grooves run transversely to the longitudinal direction of the identifier grooves in such a way that the elongate elevations and depressions, conjointly with the longitudinal direction of the identifier grooves, include in each case an angle in the range of 20° to 90°.

### BRIEF DESCRIPTION OF THE SEVERAL VIEWS OF THE DRAWINGS

Preferred embodiments of the invention will be explained and described in more detail hereunder with reference to the appended figures. In the figures:

FIG. 1 shows a schematic illustration of an exemplary vehicle tire according to the invention in a preferred embodiment;

FIG. 2 shows a schematic illustration of an exemplary identifier groove in plan view;

FIG. 3 shows a schematic sectional illustration through exemplary identifier grooves; and

FIG. 4 shows an exemplary illustration of an identifier in the sidewall of a vehicle tire according to the invention.

### DETAILED DESCRIPTION

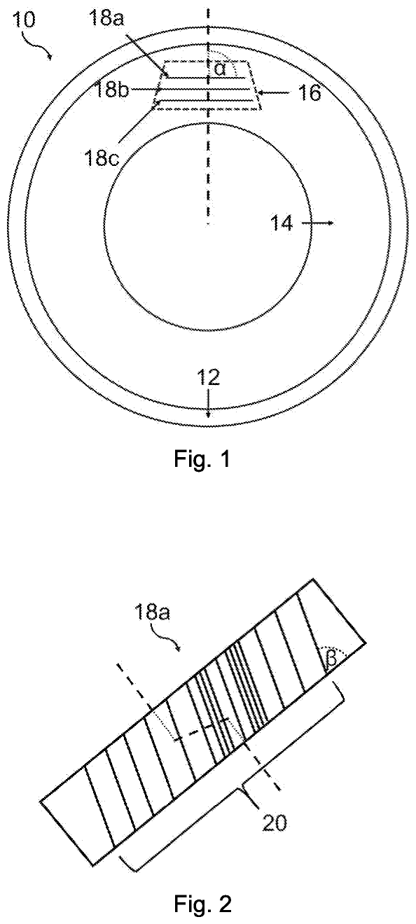

FIG. 1 shows a schematic illustration of an exemplary vehicle tire 10 according to the invention, which comprises, for example, a profiled tread 12, which is flanked in the usual manner on both sides by sidewalls 14. The vehicle tire 10 shown in FIG. 1 is designed as a pneumatic vehicle tire and can be a passenger motor vehicle tire, for example.

The exemplary vehicle tire 10 shown in the side view comprises an identifier region 16 in the upper region of the sidewall 14, in which the vehicle tire 10 is provided with an identifier, which can be, for example, a manufacturer identifier, as shown in FIG. 4.

Plotted in FIG. 1 by way of example are three identifier grooves 18a, 18b and 18c which extend in the identifier region 16, and which extend exactly horizontally over the sidewall 14 in the example shown, so that they, conjointly with the radial direction of the vehicle tire 10, which is plotted by a dashed line in FIG. 1, include an angle α of 90° at exactly one point.

FIG. 2 shows a highly schematic illustration of an identifier groove 18a as could be present in the identifier region 16 of the vehicle tire 10. FIG. 2 serves to visualize the basic principle of the invention. The identifier groove 18a shown in plan view has an inner corrugation 20, the elongate elements of which extend from one periphery to the other transversely to the longitudinal direction of the identifier groove 18a on the base of the identifier groove 18a. The elongate elements of the inner corrugation 20, which may be elevations 22a-e or depressions 24a-e, and of which in each case the centerline passing through the highest or lowest point is plotted, conjointly with the longitudinal direction of the identifier groove 18a, include an angle β which is approximately 70° in the example shown in FIG. 2.

In FIG. 2, it is visualized that the spacing of the parallel elongate elements of the inner corrugation 20 from the next elongate element varies along the longitudinal direction of the identifier groove 18a, so that the local density of the elongate elements differs at different points in the identifier groove 18a. As a result, dissimilarly light or dark regions within the identifier groove 18a are generated, owing to which—in addition to the design embodiment of the identifier grooves 18a-c, for example in terms of the groove density, groove width and groove depth—an additional dimension for adjusting the contrast is advantageously made available by the inner corrugation 20.

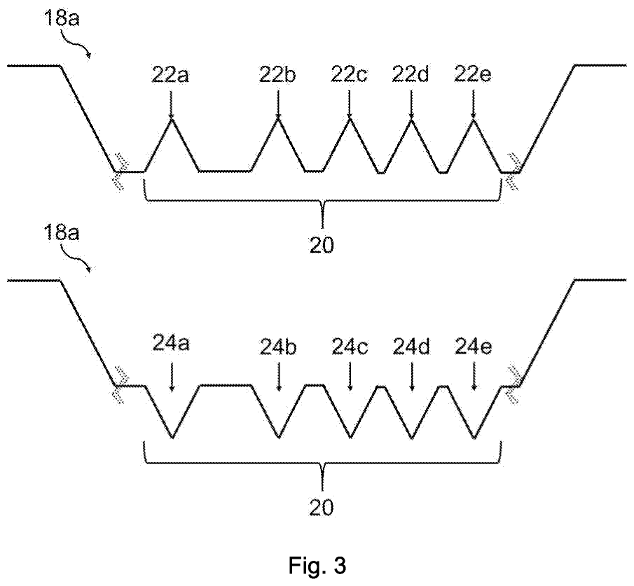

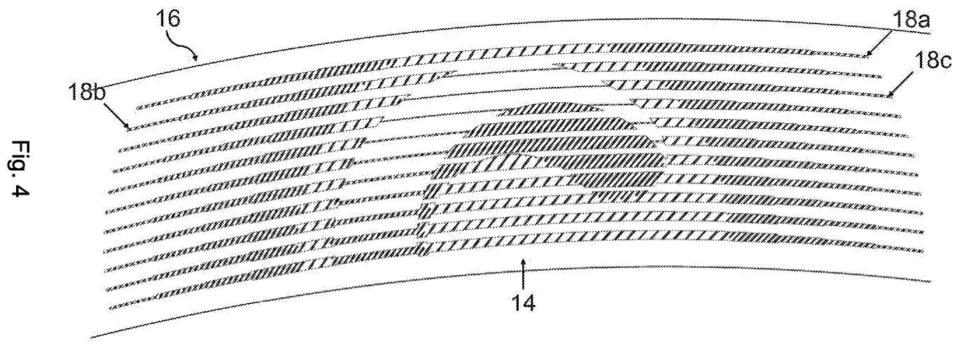

An interrupted section line which is intended to indicate a theoretical section through the identifier groove 18a is plotted in FIG. 2. Exemplary sectional illustrations corresponding to this section through the identifier groove 18a are schematically illustrated in FIG. 3, wherein the dotted regions of the section line are omitted for reasons of clarity. FIG. 3 shows two different design embodiments of the inner corrugation 20, specifically with elevations 22a, 22b, 22c, 22d and 22e, or with corresponding depressions 24a, 24b, 24c, 24d and 24e, wherein the respective elements in both cases have a triangular cross-sectional area and the maximum height or depth thereof corresponds to approximately 50% of the groove depth of the identifier groove 18a. However, according to the inventors' assessment, an embodiment in the context of the upper illustration in FIG. 3, i.e. with elevations 22a-e, is preferred.

FIG. 4 shows an exemplary identifier in an identifier region 16 on the sidewall 14 of a vehicle tire 10 according to the invention, and illustrates the interaction between identifier grooves 18a-c and the inner corrugation 20. The identifier region 16 comprises eleven identifier grooves 18a-c which, conjointly with the radial direction of the vehicle tire 10, include an angle of 90° over the entire length and accordingly describe an arc which is concentric with the vehicle tire 10. The identifier grooves 18a-c are substantially parallel in terms of their centerlines and are mutually spaced apart so as to be substantially equidistant. The groove width and the groove cross section varies along the longitudinal direction of the identifier grooves 18a-c, while the identifier grooves 18a-c are tapered in the respective end regions in terms of the groove width as well as the groove depth. All identifier grooves 18a-c comprise a large number of elongate elevations 22a-e, each extending transversely to the longitudinal direction of the identifier grooves 18a-c at an angle of approximately 50°, in the vast majority of cases extending completely through the identifier grooves 18a-c, wherein the elongate elevations 22a-e run so as to be substantially mutually parallel. By varying the embodiment of the identifier grooves 18a-c and simultaneously adapting the local density of elongate elevations 22a-e, a wide range of brightness impressions can be implemented and even fine contrast differences can be precisely adjusted. The exemplary vehicle tire 10 of FIG. 4 is also designed in a preferred form to the extent that, apart from the outermost elevations 22a-e of the outermost identifier grooves 18a-c in the identifier region 16, all elevations 22a-e by way of at least one elongate elevation 22a-e are in line with an adjacent identifier groove 18a-c and are correspondingly co-aligned therewith, wherein the elevations 22a-e in the central part of the identifier region 16 are in each case even co-aligned with elongate elevations 22a-e of a plurality of other identifier grooves 18a-c.

An identifier as illustrated in FIG. 4 can be embossed particularly efficiently in the sidewall 14 by means of a complementary vulcanization mold in the context of the vulcanization process in the manufacture of the vehicle tire 10.

### LIST OF REFERENCE SIGNS

10 Vehicle tire
12 Tread
14 Sidewall
16 Identifier region
18a-c Identifier grooves
20 Inner corrugation
22a-e Elevations
24a-e Depressions

1. A vehicle tire comprising:
a tread which is provided for contacting the road surface, and two sidewalls which adjoin the tread, wherein at least one sidewall comprises at least one identifier region;
wherein the identifier region comprises a plurality of identifier grooves which extend in the sidewall of the vehicle tire;
wherein the identifier grooves have one inner corrugation having plurality of elongate elevations and depressions which in the interior of the identifier grooves run transversely to the longitudinal direction of the identifier grooves:
wherein that the elongate elevations and depressions, conjointly with the longitudinal direction of the identifier grooves, include in each case an angle in the range of 20° to 90°.

2. The vehicle tire as claimed in claim 1, wherein the identifier region comprises five or more identifier grooves.

3. The vehicle tire of claim 1, wherein the identifier grooves at least partially have in each case a varying groove width and/or varying groove cross section along the longitudinal direction.

4. The vehicle tire of claim 1, wherein the identifier grooves include an angle in the range of 70° to 90°.

5. The vehicle tire of claim 4, wherein the inner corrugation is disposed on a base of the identifier grooves.

6. The vehicle tire of claim 5, wherein the inner corrugation comprises 15 or more elevations or depressions.

7. The vehicle tire of claim 6, wherein the elongate elevations or depressions extend in each case from one periphery of the identifier groove to the other periphery of the identifier groove.

8. The vehicle tire of claim 6, wherein the elongate elevations or depressions of an identifier groove are substantially mutually parallel.

9. The vehicle tire of claim 1, wherein the elongate elevations and/or depressions of an identifier groove are at least partially co-aligned with elongate elevations and/or depressions of an adjacent identifier groove.

10. A method for producing a vehicle tire comprising:
a) producing a non-vulcanized vehicle tire blank, comprising a vulcanizable rubber compound in at least one component of the sidewall of the non-vulcanized vehicle tire blank, and
b) vulcanizing the non-vulcanized vehicle tire blank in a vulcanization mold to obtain the vehicle tire;
wherein the vulcanization mold in the region of at least one sidewall of the vehicle tire comprises an identifier embossing region, wherein the identifier embossing region comprises a plurality of elongate identifier elevations, wherein the elongate identifier elevations each have a surface corrugation having a multiplicity of elongate elevations and/or depressions which on the surface of the elongate identifier elevations run transversely to the longitudinal direction of the identifier elevations in such a way that the elongate elevations and depressions, conjointly with the longitudinal direction of the identifier elevations, include in each case an angle in the range of 20° to 90°.

11. The method as claimed in claim 10, wherein the identifier region in the vehicle tire is molded as a negative of the identifier embossing region.
